(19) United States
(12) Patent Application Publication
(10) Pub. No.: US 2003/0233780 A1
(43) Pub. Date: Dec. 25, 2003

(54) Device to secure fishing reels to rods

(76) Inventor: Salvatore Grieco, Howell, NJ (US)

Correspondence Address: Richard C. Litman, LITMAN LAW OFFICES, LTD., P.O. Box 15035, Arlington, VA, 22215, US

(21) Appl. No.: 10/458,722

(22) Filed: Jun. 11, 2003

Related U.S. Application Data
(60) Provisional application No. 60/389,940, filed on Jun. 20, 2002.

(51) Int. Cl. A01K 87/06

(52) U.S. Cl. 43/22

(57) ABSTRACT

A kit for holding a fishing reel mounted against a fishing rod handle is made of two elastic sleeves. The rod handle includes two metal rings that hold the oppositely extending shoes of the reel seat against the handle. The two sleeves can be made of rubber and they slide onto the handle and onto at least a portion of the respective metal rings.

### CROSS-REFERENCE TO RELATED APPLICATION

This application claims the benefit of U.S. Provisional Patent Application Serial No. 60/389,940, filed Jun. 20, 2002.

### BACKGROUND OF THE INVENTION

1. Field of the Invention

The present invention relates to a kit for assembling a fishing reel to a fishing rod and a method of assembling a fishing reel to a fishing rod. In particular, the kit is made up of two elastic (rubber) cylindrical sleeves that are placed onto a fishing rod which has two respective metal sleeves holding the reel in place.

2. Description of Related Art

It is well known to fasten fishing reels to rods using any suitable fastening device, such as screws, adhesive, etc. However, when using the type of fishing rods that use metal sleeves to hold the shoes of a fishing reel in place on the handle of the fishing rod, the metal sleeves often slide away from the reel shoes, thereby allowing the reel to physically separate from the rod handle. Therefore, it is desired to apply an additional cylindrical layer of support onto the metal sleeves to prevent them from sliding away from the reel shoes during use.

U.S. Pat. No. 2,826,852, issued to Wardrip on Mar. 18, 1958, teaches the use of a finger grip attachment for a reel which is mounted to the handle of a fishing pole by a T-shaped mounting bracket with two rings which slide over the ends of the mounting bracket crossbar to hold it firmly against the handle. No additional elastic sleeves are used over the metal rings.

U.S. Pat. No. 3,410,017, issued to Wilson on Nov. 12, 1968, teaches a cylindrical handgrip that conforms to and holds a reel onto a fishing rod. The grip can be made of resilient plastic or rubber. U.S. Pat. No. 3,641,696, issued to Fleischer on Feb. 15, 1972, teaches the use of windings to secure a reel to a rod.

U.S. Pat. No. 3,975,855, issued to McKeown on Aug. 24, 1976, describes application of a removable cylindrical handgrip onto one end of the reel and a removable collar on the opposite end. U.S. Pat. No. 4,453,332, issued to Wightman on Jun. 12, 1984, discloses the use of two handgrips and two collars on either end of the reel seat. U.S. Pat. No. 4,845,882, issued to Collins on Jul. 11, 1989, teaches the use of two rings on either end of the reel seat.

None of the above inventions and patents, taken either singly or in combination, is seen to describe the instant invention as claimed.

### SUMMARY OF THE INVENTION

The present invention is directed to a reel-to-rod securing kit, a fishing rod and reel including securing elastic sleeves for securely attaching a fishing reel to a fishing rod, and a method of securing a fishing reel to a fishing rod. More particularly, the kit is made up of two elastic (e.g., rubber) sleeves that are placed respectively onto the two ends of the reel shoes, i.e., the portion of the reel that contacts the rod. Even more particularly, the two elastic sleeves are placed over existing metal rings commonly used to mount reels onto fishing rod handles. The elastic sleeves can be removed or reapplied as necessary, e.g., when changing reels.

Accordingly, it is a principal object of the invention to provide a kit for securing a fishing reel to a fishing rod.

It is another object of the invention to provide a fishing rod and reel kit including rubber sleeves to secure the reel to the rod.

It is a further object of the invention to provide a method of using two rubber sleeves to secure a fishing reel to a fishing rod.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a device to secure fishing reels to rods according to the present invention, showing the two rubber cylindrical sleeves.

FIG. 2A shows a perspective view of a fishing rod with the reel in the process of being attached to the rod handle.

FIG. 2B shows an exploded view of a fishing rod with the reel attached.

FIG. 3 shows a perspective view of the completed fishing rod and attached reel.

Similar reference characters denote corresponding features consistently throughout the attached drawings.

### DETAILED DESCRIPTION OF THE PREFERRED EMBODIMENTS

The present invention is directed to a kit made up of two elastic sleeves used to hold a fishing reel to a fishing rod. Preferably the fishing rod is an ultralight rod that is typically used in freshwater fishing.

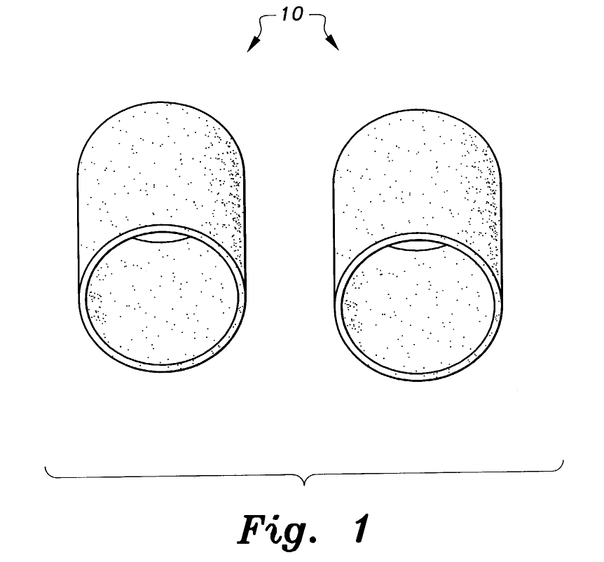

FIG. 1 shows a perspective view of the two elastic sleeves 10, showing an approximate relative length-to-diameter relationship.

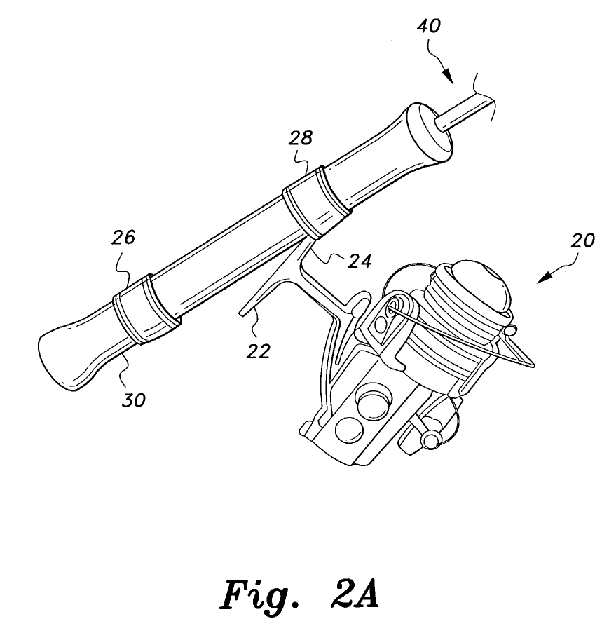

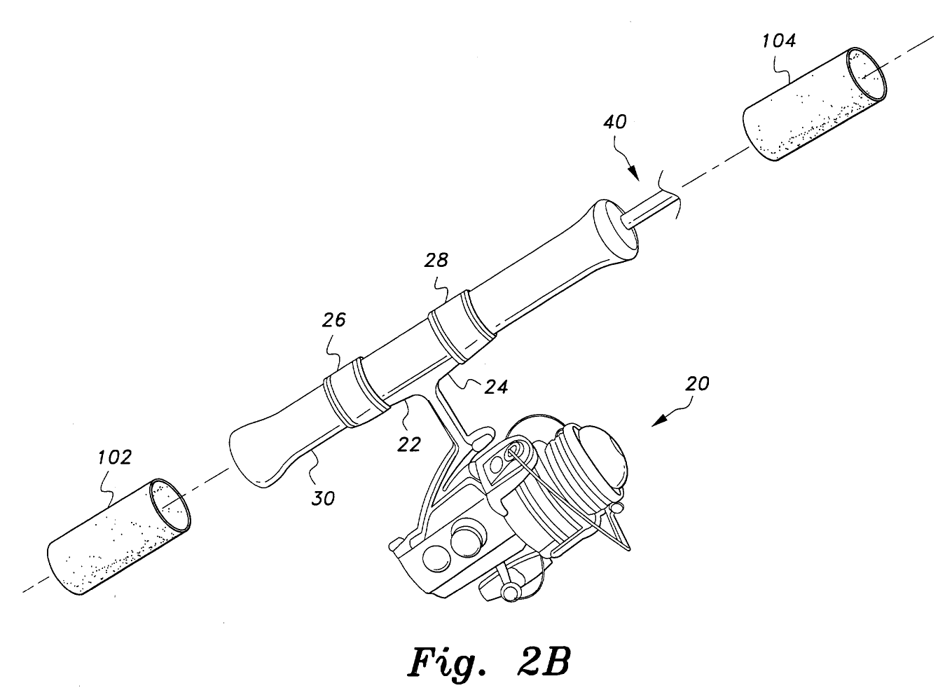

FIG. 2A shows an exemplary fishing rod 40 with a handle 30 of the type in which two metal rings, 26 and 28, are used to hold the mounting shoes of a reel in place on the handle 30 of the rod. When a conventional reel 20, having opposed mounting shoes, 22 and 24, is mounted onto the handle, the metal rings, 26 and 28, are slid onto the respective reel shoes, 22 and 24, i.e., the extended portions of the mounting bracket of the reel that directly contact the handle and which extend in opposite directions along the surface of the handle, as shown. FIG. 2A shows one of the metal rings, 28 slid partially in place onto shoe 24. The reel seat is then placed against the handle and the second metal ring 26 is then slid onto shoe 22 until it is in the arrangement shown in FIG. 2B. The handle used with ultralight rods is commonly made partially or entirely of a soft woody material, such as cork. The reel used with ultralight rods is typically a spinning reel.

FIG. 2B is an exploded view showing elastic sleeves, 102 and 104 in alignment with the respective metal sleeves, 26 and 28, along the axis of the fishing rod handle 30.

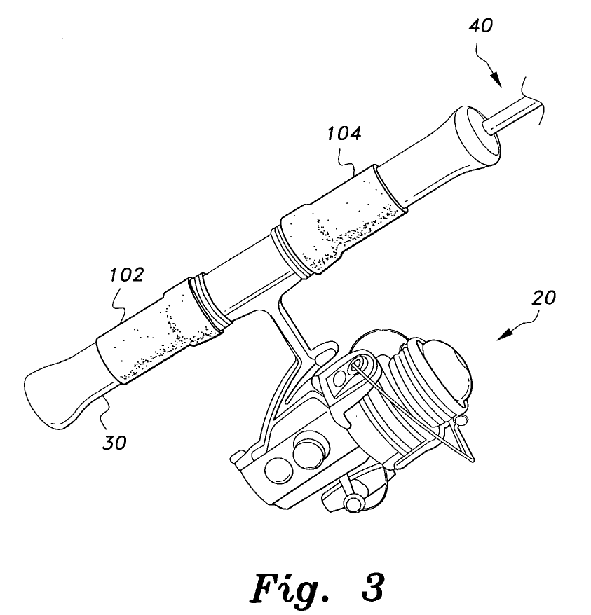

FIG. 3 shows a perspective view of the fully assembled fishing rod with the fishing reel snugly mounted by sliding the rubber sleeves 102 and 104 over the metal rings 26 and 28. A portion of the metal rings is shown projecting slightly from the elastic sleeves 102 and 104, however, the elastic sleeves can also be applied so that the metal rings are completely covered as well. The elastic sleeves 102 and 104 are sufficiently resilient that they prevent metal rings 26 and 28 from sliding axially on the handle 30, thus securing the reel to the handle 30.

The elastic sleeves can be any suitable resilient material, such as natural or synthetic rubber, that adequately holds the metal sleeves securely in place on the reel shoes. The sleeves can be cut, for example, from a bicycle tire inner tube.

In an alternative embodiment, the elastic sleeve can be a strip of elastomeric material that is wrapped onto itself, i.e., a sleeve in which the sleeve is cut lengthwise to produce a straight, flat strip of material. In this case, the elastomeric strip material is wrapped onto the metal rings and the ends fastened together to hold the strip firmly onto the rings. The overlapping ends of material can be provided with a hook-and-loop fastening material, e.g., VELCRO, to close the ends together. The material of the elastomeric strip can be made of bands of rubber, neoprene, or neoprene and rubber combined. Also, the hook and loop material can be replaced with clips, e.g., a pair of mating clips, to hold the sleeve in place.

It is to be understood that the present invention is not limited to the sole embodiments described above, but encompasses any and all embodiments within the scope of the following claims.

I claim:

1. A kit for holding a fishing reel having a mounting bracket with two oppositely extending mounting shoes to a fishing rod having a handle and two metal rings on the handle for holding the shoes of the reel onto the handle, the kit comprising:
two elastic cylindrical sleeves, the sleeves being substantially identical in size and having a diameter about equal to an outer diameter of the fishing rod handle, such that the sleeves are removably slidable onto the handle and onto the metal rings in order to hold the metal rings and reel shoes securely in place during use.

2. A method of using the kit of claim 1, comprising:
placing the reel against the rod handle such that the shoes extend along a direction parallel with an axis defined by the rod;
sliding the two metal rings of the handle onto the respective shoes of the reel; and
sliding the two sleeves on the handle, respectively, onto at least a portion of the metal sleeves, thereby holding the reel shoes securely in place on the rod handle during use.

3. The kit of claim 1, wherein the elastic sleeves are made of rubber.

4. A fishing rod, comprising:
a fishing reel having a mounting bracket including two oppositely extending mounting shoes;
a rod having a handle and two metal rings axially slidable on the handle, the reel being mounted on the handle with the metal rings slidably disposed over the shoes of the reel; and
two elastic cylindrical sleeves, the sleeves being identical in size and having a diameter about equal to an outer diameter of the fishing rod handle, the sleeves being elastic disposed about the metal rings in order to prevent the metal rings from sliding off the shoes.

5. The fishing rod of claim 4, wherein the elastic sleeves are made of rubber.

6. The fishing rod of claim 4, wherein the handle is made at least partially of cork.

7. The fishing rod of claim 4, wherein the rod is an ultralight rod.
